(19) United States
(12) Patent Application Publication
(10) Pub. No.: US 2009/0208683 A1
(43) Pub. Date: Aug. 20, 2009

(54) ALIGNMENT SYSTEM AND METHODS FOR COMPOSITE ASSEMBLIES

(76) Inventor: William L. Rodman, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 12/330,391

(22) Filed: Dec. 8, 2008

Related U.S. Application Data
(60) Provisional application No. 60/992,797, filed on Dec. 6, 2007.
(60) Provisional application No. 61/099,372, filed on Sep. 23, 2008.

(51) Int. Cl. B32B 1/02

(52) U.S. Cl. 428/35.7; 428/34.1

(57) ABSTRACT

A complex-shaped, three-dimensional fiber reinforced composite assembly may be formed by aligning complex-shaped, three-dimensional, pressurizable members to form fiber reinforced composite assemblies. More specifically, the pressurizable members may include indexing and interlocking features for alignment with one another and possibly with other structural components that may be embedded in the assembly. In one embodiment, the indexing features permit the pressurizable members to be snap fit together. In another embodiment, an interlocking member is received in grooves formed in the macro-cellular cores. The interlocking member and thus the grooves may be selected to create uniquely shaped stiffeners for the composite assembly.

### PRIORITY CLAIM

This application claims priority to U.S. Provisional Patent Application Nos. 60/992,797 (filed on Dec. 6, 2007) and 61/099,372 filed Sep. 23, 2008, and of which the subject matter of each is incorporated herein by reference in its entirety.

### FIELD OF THE INVENTION

The invention is generally related to aligning complex-shaped, three-dimensional, pressurizable members, which may be referred to as pressurizable macrocell components, to form fiber reinforced composite assemblies, and more specifically indexing and interlocking the pressurizable macrocell components with one another and possibly with other structural components.

### BACKGROUND OF THE INVENTION

A composite component is a term generally used to describe any part consisting of at least two constituents that are combined yet retain their physical and chemical identities. One type of composite component is a particulate reinforced composite (PRC) in which particulates of a selected material are embedded or bonded into a matrix. An advanced composite component is a term generally used to describe fibers of high strength and modulus embedded in or bonded to a matrix, such as a resin, metal, ceramic, or carbonaceous matrix. The fibers may be continuous fibers, short fibers, or whiskers. The resin type matrix may be a polymerized synthetic or a chemically modified natural resin, which may include but is not limited to thermoplastic materials such as polyvinyl, polystyrene, and polyethylene and thermosetting materials such as polyesters, epoxies, and silicones. Typically, a distinct interface or boundary is present between the fibers and the matrix material. It is appreciated that the composite component produces a combination of properties that cannot be achieved with either of the constituents acting alone.

A composite component is typically produced by a multi-step process that begins by laying up the fibers generally in swatches of material known as laminates or plies on an impervious surface. To form the matrix about the fiber plies, the plies may be pre-impregnated with the matrix material or may be un-impregnated. The un-impregnated fibers may be embedded or bonded in the matrix material by using injection molding, reaction injection molding (RIM), resin infusion, or other matrix embedding or bonding techniques. Once the fiber plies are arranged in a desired configuration, compaction techniques such as vacuum bagging are advantageously employed to remove voids from the fiber plies. The matrix material surrounding the plies may be cured employing ovens, electron beams, ultraviolet, infrared light sources, autoclave cured. Curing may be carried out at room (i.e., ambient) or elevated temperatures.

One existing manufacturing process for producing large, complex-shaped, three-dimensional, fiber reinforced composite components and structures includes arranging fiber plies arranged on plaster mandrels to form the complex shape. Fiber reinforced plies are laid up and impregnated on the plaster mandrels, which have been previously varnished to seal them. The resulting structure is vacuum bagged and cured. The plaster mandrel is removed by striking it through the laid up, crumbling the plaster mandrel to leave the hollow composite component. This technique is commonly used to produce structures such as complex-shaped, air conditioning ducts. This type of tooling may include locking features that hold the tool's complex shape.

If the strength of the component is at issue, steel, aluminum, or invar tooling materials may be used to create shapes that can be fastened or otherwise coupled together to create a mold surface for laying up the fiber plies. For example, an auxiliary power unit inlet duct for an airplane typically requires structural materials that exceed the strength requirements obtainable from the plaster mandrel techniques described above.

Another method of producing large composite core structures formed by vacuum assisted resin transfer molding is described in U.S. Pat. No. 6,159,414 to Tunis, III et al. (Tunis). Tunis describes making composite structures by employing hollow cell or foam block-shaped cores. The cores are wrapped with fiber materials and arranged in a mold. The assembly is sealed under a vacuum bag to a mold surface. One or more main feeder conduits communicate with a resin distribution network of smaller channels which facilitates flow of uncured resin into and through the fiber material. The resin distribution network may comprise a network of grooves formed in the surfaces or the cores and/or rounded corners of the cores. The network of smaller channels may also be provided between the vacuum bag and the fiber material, either integrally in the vacuum bag or via a separate distribution medium. Resin, introduced under vacuum, travels relatively quickly through the main feeder channel(s) and into the network of smaller channels. After penetrating the fiber material to reach the surface of the cores, the resin again travels relatively quickly along the cores via the grooves in the cores or the spaces provided by the rounded corners to penetrate the fiber material wrapped around and even between the cores. The resin is then cured after impregnating the fiber material to form a three-dimensional, fiber reinforced composite component and structure.

### SUMMARY OF THE INVENTION

The invention generally relates to structural composite assemblies formed by aligning complex-shaped, three-dimensional, pressurizable members, which may be referred to as pressurizable macro-cellular cores, to form fiber reinforced composite assemblies, and more specifically indexing and interlocking the pressurizable macro-cellular cores with one another and possibly with other structural components that may be embedded in the assembly. One method for aligning the macro-cellular cores includes providing self-indexing and/or interlocking features to build up larger and more complex assemblies. The structural composite assemblies and the methods of making the same may advantageously reduce the number of assembly steps, provide better load transfer paths between structural elements, produce stronger assemblies, and reduce the overall manufacturing costs.

In accordance with an aspect of the invention, a composite structural assembly having a first pressurizable member having sufficient rigidity for supporting fiber plies thereon in a first desired shape before pressurization. The first pressurizable member includes a first outer surface and a first inner surface forming a first wall that defines a first volumetric region with the first wall having a first opening to permit internal pressurization of the first volumetric region. The first pressurizable member further includes a first indexing feature located on a first selected portion of the first outer surface. The composite structural assembly includes a second pressurizable member having sufficient rigidity for supporting fiber plies thereon in a second desired shape before pressurization. The second pressurizable member includes a second outer surface and a second inner surface forming a second wall that defines a second volumetric region with the second wall having a second opening to permit internal pressurization of the second volumetric region. The second pressurizable member further includes a second indexing feature located on a second selected portion of the second outer surface. And, the composite structural assembly includes an interlocking member shaped and sized to complementarily engage the first and second indexing features to align the first pressurizable member with the second pressurizable member.

In accordance with another aspect of the invention, a composite structural assembly includes a first pressurizable member having sufficient rigidity for supporting fiber plies thereon in a first desired shape before pressurization. The first pressurizable member includes a first outer surface and a first inner surface forming a first wall that defines a first volumetric region with the first wall having a first pressure port to permit internal pressurization of the first volumetric region. The first pressure port is configured as a first indexing feature located on a first selected portion of the first outer surface. In addition, the composite structural assembly includes a second pressurizable member having sufficient rigidity for supporting fiber plies thereon in a second desired shape before pressurization. The second pressurizable member includes a second outer surface and a second inner surface forming a second wall that defines a second volumetric region with the second wall having a second opening sized to receive the first pressure port and permit fluid communication between the first volumetric region and the second volumetric region.

### BRIEF DESCRIPTION OF THE DRAWINGS

Preferred and alternative embodiments of the present invention are described in detail below with reference to the following drawings:

FIG. 1 is an exploded perspective view of a composite assembly having interlocking features, indexing features, embedded fittings, and an interlocking member according to an embodiment of the invention;

FIG. 2 is a perspective view of the composite assembly of FIG. 1;

FIG. 3 is a perspective view of a composite assembly having interlocking features and indexing features according to an embodiment of the invention;

FIG. 4A is a cross-sectional view of a composite assembly in a tool having interlocking pins according to an embodiment of the invention;

FIG. 4B is a perspective view of the composite assembly of FIG. 4A; and

FIGS. 5-8 are schematic views of complex shaped stiffeners formed by selectively choosing various cross-sectional groove shapes that are formed in macro-cellular cores according to an embodiment of the invention.

### DETAILED DESCRIPTION OF THE PREFERRED EMBODIMENT

As described in detail in U.S. patent application Ser. No. 11/835,261, filed by the same inventor on Aug. 7, 2007 and which is incorporated herein in its entirety, a complex-shaped, three-dimensional fiber reinforced composite structure may be formed by using counteracting acting pressures applied to a structural lay-up of fiber plies. The fiber plies are arranged on one or more pressurizable members, which are hereinafter referred to as macro-cellular cores or macro-cells for short. The macro-cellular cores may become an integral part of the final product, or may be removed, depending on accessibility issues. In a preferred embodiment, the macro-cellular cores are hollow rotomolded thermoplastic components, blow molded thermoplastic components, superplastic formed metallic components, or twin sheet vacuum formed (TSVF) components having an opening or vent. The opening or vent allows an inner surface of the macro-cellular cores to be vented or pressurized such that it is expanded or inflated against the fiber plies. Advantageously, the vented macro-cellular cores allow the complex-shaped, three-dimensional fiber reinforced composite structure to be produced using elevated temperature, pressure, and/or autoclave techniques. By means of the opening, pressure within the macro-cellular cores may be equalized as temperature rises or additional pressure may be applied, as in the use of an autoclave. In one embodiment, a number of the macro-cellular cores, which may be of different sizes and have complex shapes, are arranged to form a large, complex-shaped assembly for fiber plies that may be selectively oriented and arranged thereon.

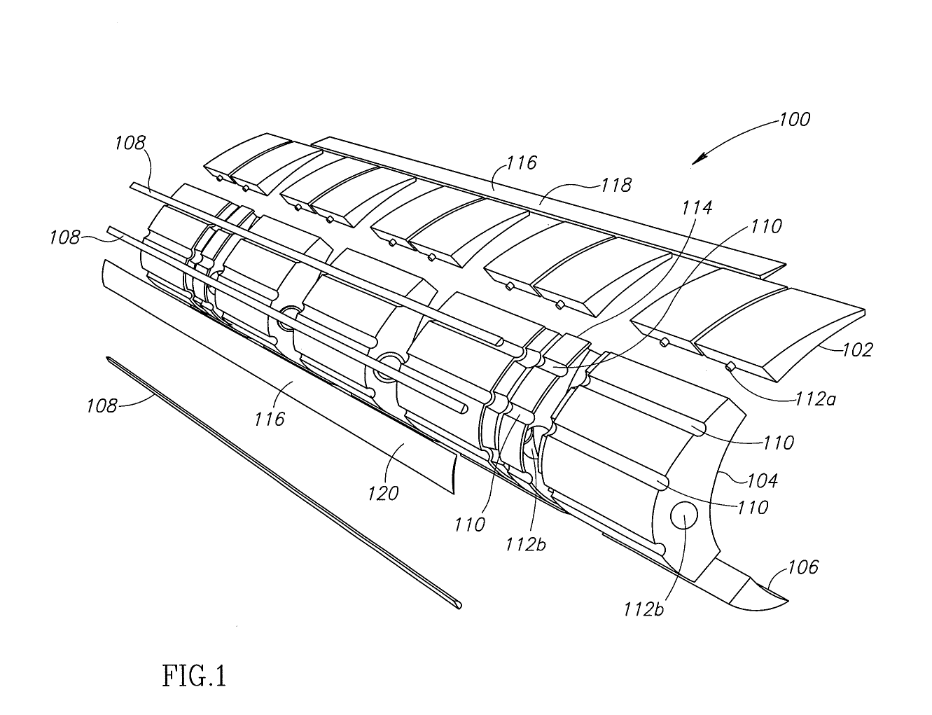

FIG. 1 shows an assembly 100 having upper macro-cellular cores 102, intermediate macro-cellular cores 104, and lower macro-cellular cores 106 being arranged together to form the assembly 100. Each of the cores 102, 104, 106 may each take the form of any closed-form surface of practically any size, shape or configuration. In the illustrated embodiment, the cores 102, 104, 106 take the form of aerodynamic surfaces, for example the aerodynamic surfaces for a leading edged slat system coupled to a wing.

The assembly 100 includes interlocking members 108 that may be slideably received, snap-fit into, or otherwise received into the recesses, grooves or channels 110 formed in the cores 102. In addition, the cores 102, 104 may include indexing features 112a, 112b. By way of example, the indexing features 112a of the core 102 are protuberances 112a that extend from the core 102 for engagement with complementary openings (not shown) formed in the core 104. Further by way of example, the indexing feature 112b of the core 104 is a through opening 112b sized to receive a rod or a tube (not shown). Thus, when the cores 104 are initially placed in a tool they may be located and rotated into alignment with each other by sliding the tube through the through openings 112b. The tube, in turn, may be supported by the tool.

The assembly 100 may further include other types of structural components 114 such as a metallic spar fitting shown in the illustrated embodiment. The structural component 114 may include recesses, grooves or channels 110 for receiving the interlocking members 108 and may further include one or more indexing features, such as a the through opening 112b. Additionally, the assembly 100 may include non-pressurizable surfaces 116. For example, the illustrated leading edged slat system includes a trailing edge surface 118 bonded to the cores 102 and a reinforcement strap 120 bonded to a portion of the cores 104. The various cores 102, 104, 106, the structural components 114, and the interlocking members 108, once assembled, may also be bonded with one another to provide a more robust and stable assembly 100.

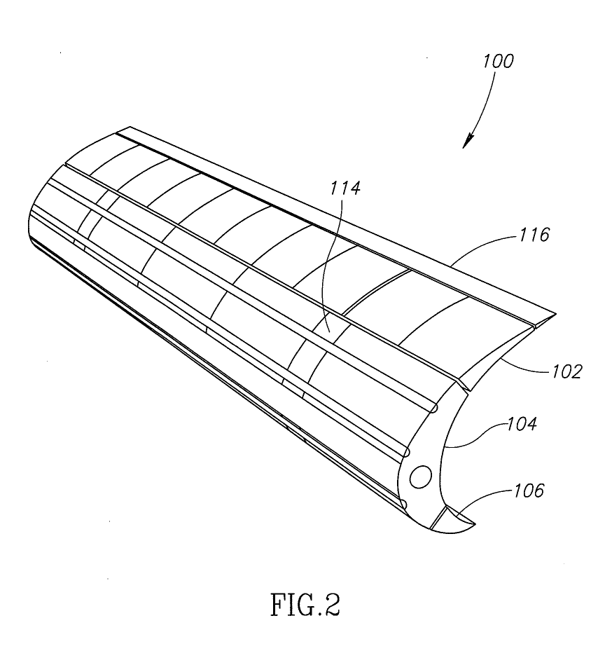

FIG. 2 shows the assembly 100 after the various cores 102, 104, 106, the structural components 114, and the interlocking members 108 have been assembled. It is appreciated that the various cores 102, 104, 106, the structural components 114, and the interlocking members 108 may take a variety of shapes and sizes and be made from a variety of materials.

The structural components 114 may take the form of embedded lugs or doublers. In conventional composite assemblies, embedded lugs or doublers are rarely utilized because of the difficulties associated with inspecting the composite materials b, as well as the likelihood of inadequate pressure distribution on all surfaces. In some cases where embedded lugs or doublers are employed, such as metallic doublers, they are generally limited to two-dimensional machined plates. One purpose of a structural component 114 is to act as a load distribution mechanism across the face of the composite assembly 100 or in other cases a structural member that transfers load between the composite components.

The structural components 114 may also take the form of metallic fittings, which are commonly used on moveable structure because of high load concentrations. The structural components 114 pick up load from the composite component and transfer the load to other structure, such as an attach point on an aircraft. Conventionally, metallic have large flanges with resulting large fastener patterns because the composite components are softer materials; however the larger flanges cause excess weight. One way to reduce the excess weight is to embed the metallic fitting in the composite assembly 100.

As discussed above, the composite assembly 100 may be pressurized both internally and externally, which further means that pressure may be applied to desired surfaces of an embedded lug or fitting, whether metal or non-metal. Advantageously, design issues such as edge margin, pull-through, minimum gauge, squared and flat surfaces (and edges) may be eliminated from design consideration and the overall size and weight of the embedded lug or fitting may be substantially reduced without a reduction in overall strength or load transfer capability.

The interlocking members 108, indexing features 112a, 112b, or both permit the design surfaces of the assembly 100 to become located in space according to a desired axis system, such as a Cartesian or spherical coordinate system. In an aerospace environment, for example, the design surfaces of the assembly 100 may also be oriented with respect to a pitch, yaw and roll coordinate system. In addition, one or more of the design surfaces of the assembly 100 may operate as a datum or reference surface used to locate other features and aspects of the assembly 100.

The terms “index,” “interlock” or both as used herein includes techniques and processes where the macro-cellular cores and other structural members of the assembly 100, with fiber plies selectively arranged thereon, are arranged or otherwise referenced or registered together in a desired manner such that one or more design surfaces of the assembly 100 are placed against a machined or tooled surface (e.g., metallic, ceramic, or composite). In one embodiment, the interlocking members, indexing features, or both allow for a desired alignment of the components making up the assembly 100. In some instances, an interlocking member may operate as an indexing feature or vice-versa. By way of example, the interlocking member 108 of the example leading edged slat system may perform both interlocking and indexing functions for the assembly 100.

In one example, the terms “indexing, “interlocking” or both may include the configuration of macro-cellular cores with fiber plies that are connected to one another in a three-dimensional space in accordance with a desired engineering scheme. By sequencing the connection of the macro-cellular cores with other structural features permits the creation of a complex assembly 100 that, when cured, becomes a monolithic assembly or system.

The indexing features may take many different forms, for example female-to-male connections, components that nest within other components, and components that “snap together.” In one example, the indexing features may take the form of “cup and socket” connections such as a passageway, duct or other opening extending through or at least partially into one or more of the macro-cellular cores to properly align each core in the assembly 100. In turn, the passageway, duct or other opening may receive a pin, cylinder, dowel or other structural component.

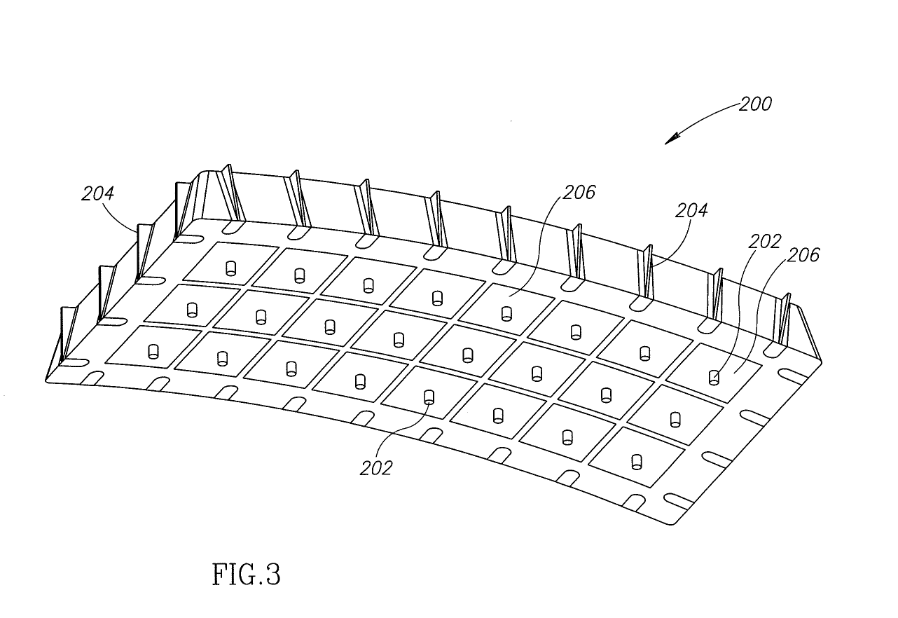

FIG. 3 shows an assembly 200 having a plurality of indexing features 202 and a plurality of control features 204. In the illustrated embodiment, the assembly 200 may take the form of a panel. The indexing features 202 may also function as pressure ports to permit pressurization of pressurizable members 206. The control features 204 operate as connection mechanisms for attaching other structure.

FIGS. 4A and 4B show another assembly 300 having another type of a control feature 302 that extends between at least two macro-cellular cores 304 in a complex assembly. In the illustrated embodiment, the macro-cellular cores 304 are formed around the control features 302, which take the form of tubes. The control features 302 and macro-cellular cores 304 are located in a tool 306 for pressurizing as described in U.S. patent application Ser. No. 11/835,261. After curing, the tubes 302 may be released from the tool 306 and the macro-cellular cores 304. If a slip fit is desired, the tubes 302 may be coated with a low friction material or lubricating film to aid extraction. Alternatively, the tubes 302 may be permanently bonded to form part of the assembly 300.

Another example of a control feature may take the form of a lug or fitting to be fastened to the assembly 300. By way of example, the control feature may take the form of a cavity for receiving and precisely locating the lug or fitting, which may be surrounded by fibers. In one embodiment, a metallic insert may be combined with the macro-cellular core to form the cavity. Specifically, the macro-cellular cores may be configured to fit around the insert such that during pressurizing and curing the fiber plies on the macro-cellular cores are urged against the metallic insert. Further, the metallic insert may be connected to the tool for more accurate placement.

Yet another example of a control feature is a selected surface or a combination of surfaces. One method of creating the surface is to insert a plate between at least two macro-cellular cores or between one macro-cellular core and the tool. When the macro-cellular cores are removed, the plate may also be removed to obtain a smooth surface.

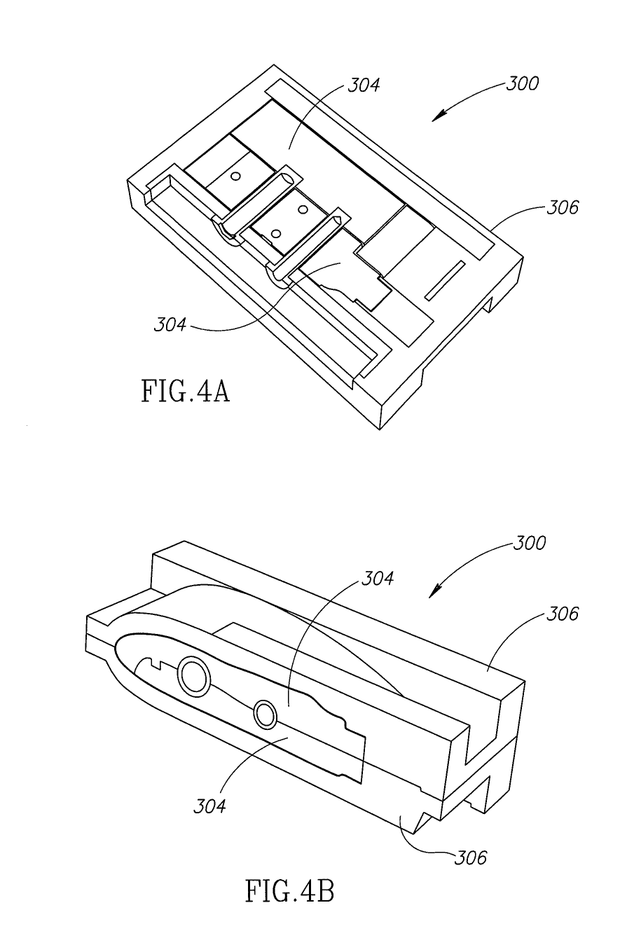

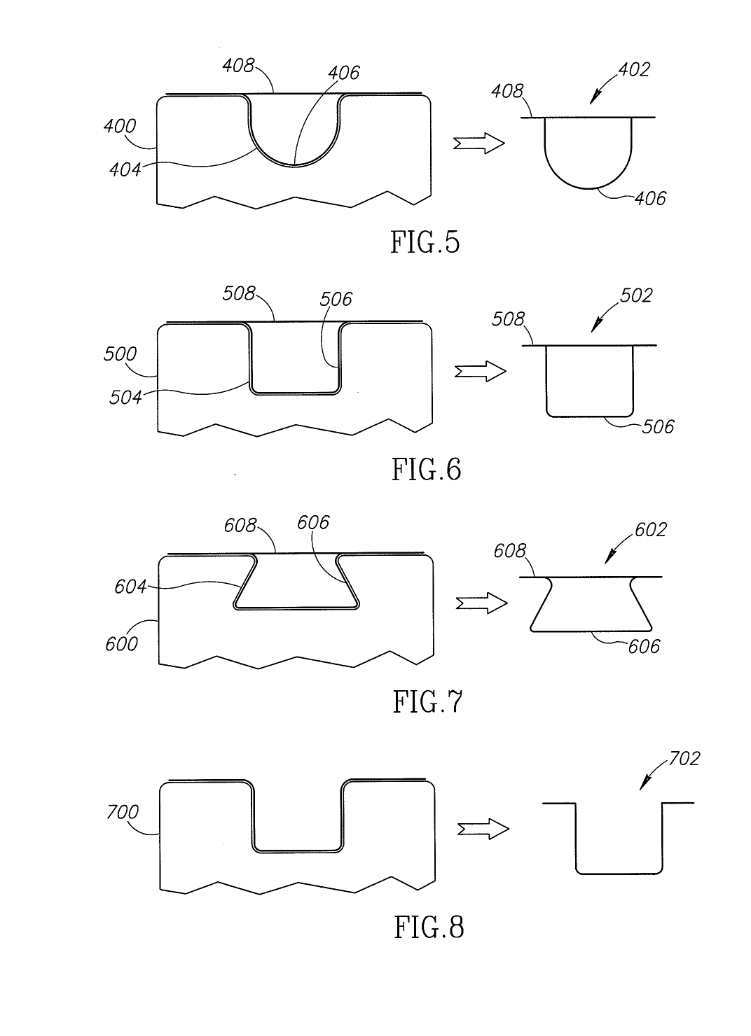

FIGS. 5-8 show macro-cellular cores 400, 500, 600, 700 having selected fiber-reinforced stiffeners 402, 502, 602, 704 which may be formed by choosing a cross-sectional shape for a channel or groove 404, 504, 604, 704 formed in the macro-cellular cores. By way of example, FIG. 5 shows a hat-shaped stiffener 402 formed by laying a first set of fiber plies 406 in a semi-circular groove 404 and then laying a second set of fiber plies 408 over the groove 404. FIG. 6 shows a rectangular-shaped stiffener 502 formed by laying a first set of fiber plies 506 in a semi-circular groove 504 and then laying a second set of fiber plies 508 over the groove 504. FIG. 7 shows a trapezoidal-shaped stiffener 602 formed by laying a first set of fiber plies 606 in a semi-circular groove 604 and then laying a second set of fiber plies 608 over the groove 604. And lastly, FIG. 8 shows an open-channeled stiffener 702 formed by eliminating the second set of fiber plies as shown in FIG. 6.

As described above, aspects of the invention enable the manufacture of complex-shaped fiber-reinforced composite structures that otherwise could not be produced or would require substantial advanced and expensive assembly techniques. In addition, aspects of the invention may allow for the manufacture of a complex-shaped fiber-reinforced composite structure having substantially reduced weight when compared to a similar metallic component, enable radical new designs and structural configurations, and may lower production costs of complex-shaped fiber-reinforced composite structures.

Accordingly, the scope of the invention is not limited by the disclosure of the preferred embodiment. Instead, the invention should be determined entirely by reference to the claims that follow.

1. A composite structural assembly comprising:
a first pressurizable member having sufficient rigidity for supporting fiber plies thereon in a first desired shape before pressurization, the first pressurizable member having a first outer surface and a first inner surface forming a first wall that defines a first volumetric region with the first wall having a first opening to permit internal pressurization of the first volumetric region, the first pressurizable member further having a first interlocking feature located on a first selected portion of the first outer surface;
a second pressurizable member having sufficient rigidity for supporting fiber plies thereon in a second desired shape before pressurization, the second pressurizable member having a second outer surface and a second inner surface forming a second wall that defines a second volumetric region with the second wall having a second opening to permit internal pressurization of the second volumetric region, the second pressurizable member further having a second interlocking feature located on a second selected portion of the second outer surface; and
an interlocking member shaped and sized to complementarily engage the first and second interlocking features to align the first pressurizable member with the second pressurizable member.

2. The composite structural assembly of claim 1, wherein the pressurizable members are selected from the group consisting of roto-molded thermoplastic members, blow molded thermoplastic members, super-plastic formed metallic members, and twin sheet vacuum formed members.

3. The composite structural assembly of claim 1, wherein the first opening aligns with the second opening when the interlocking member engages the first and second interlocking features.

4. The composite structural assembly of claim 1, further comprising:
a seal arranged with respect to the first and second openings to permit fluid communication between the first and second pressurizable members while minimizing fluid leakage.

5. The composite structural assembly of claim 1, wherein the first interlocking feature is a channel formed in the first selected portion of the first outer surface.

6. The composite structural assembly of claim 5, wherein the interlocking member is configured to be received in the channel.

7. The composite structural assembly of claim 1, wherein the interlocking member is an extruded thermoplastic member.

8. The composite structural assembly of claim 1, further comprising:
a plurality of structural fibers arranged on selected portions of the pressurizable members and on the interlocking member to form a structural shape.

9. The composite structural assembly of claim 8, wherein the structural shape includes a D-shaped cross section.

10. The composite structural assembly of claim 8, wherein the structural shape includes a T-shaped cross section.

11. The method of claim 1, wherein the interlocking member is closely received in the first and second interlocking features.

12. The composite structural assembly of claim 1, wherein the first opening of the first pressurizable member includes a protuberance extending from the first pressurizable member, the protuberance closely receivable in the second opening of the second pressurizable member.

13. The composite structural assembly of claim 1, wherein the second opening of the second pressurizable member includes a protuberance extending from the second pressurizable member, the protuberance closely receivable in the first opening of the first pressurizable member.

14. The composite structural assembly of claim 1, wherein the first and second interlocking features are through holes formed in the pressurizable members and the interlocking member is sized to be closely received by the through holes.

15. A composite structural assembly comprising:
a first pressurizable member having sufficient rigidity for supporting fiber plies thereon in a first desired shape before pressurization, the first pressurizable member having a first outer surface and a first inner surface forming a first wall that defines a first volumetric region with the first wall having a first pressure port to permit internal pressurization of the first volumetric region, the first pressure port configured as a first indexing feature located on a first selected portion of the first outer surface; and
a second pressurizable member having sufficient rigidity for supporting fiber plies thereon in a second desired shape before pressurization, the second pressurizable member having a second outer surface and a second inner surface forming a second wall that defines a second volumetric region with the second wall having a second opening sized to receive the first pressure port and permit fluid communication between the first volumetric region and the second volumetric region.

16. The composite structural assembly of claim 15, further comprising:
an interlocking member configured to engage and substantially align the first and second pressurizable members.

17. The composite structural assembly of claim 16, wherein the interlocking member complementarily engages interlocking features formed in the pressurizable members.

18. The composite structural assembly of claim 15, wherein the first and second pressurizable members include other complementarily shaped indexing features.

19. The composite structural assembly of claim 15, wherein the first and second outer surfaces included features for being controllably located with respect to a tooling surface.

20. The composite structural assembly of claim 15, wherein the first and second outer surfaces are contoured to be controllably located with respect to a tooling surface.
